(19) United States
(12) Patent Application Publication
(10) Pub. No.: US 2008/0294748 A1
(43) Pub. Date: Nov. 27, 2008

(54) PROXY BETWEEN NETWORK FILE SYSTEM VERSION THREE AND NETWORK FILE SYSTEM VERSION FOUR PROTOCOL

(76) Inventors: William Boyd Brown, Austin, TX (US); Rodney Carlton Burnett, Austin, TX (US); Duen-wen Hsiao, Austin, TX (US)

Correspondence Address: IBM CORP (YA);C/O YEE & ASSOCIATES PC, P.O. BOX 802333, DALLAS, TX, 75380, US

(21) Appl. No.: 11/751,284

(22) Filed: May 21, 2007

(51) Int. Cl. G06F 15/16

(52) U.S. Cl. 709/219

(57) ABSTRACT

A computer implemented method, apparatus, and computer usable program code for transmitting data. Transmission of the data is requested from a first data processing system to a second data processing system. The first data processing system uses a first network file system version and the second data processing system uses a second network file system version. A request is formed by requesting transmission of the data. The request is in a first protocol associated with the first network file system version. The request is received at a proxy server before transmitting the request from the first data processing system to the second data processing system. The request is converted at the proxy server to a second request. The second request is in a second protocol associated with the second network file system version. The second request is transmitted to the second data processing system and stored in a memory.

### BACKGROUND OF THE INVENTION

1. Field of the Invention

The present invention relates generally to an improved data processing system and in particular to a method and apparatus for smoothing a transition between network file system versions. Still more particularly, the present invention relates to a computer implemented method, apparatus, and a computer usable program product for a proxy server between clients using network file system version three and servers using network file system version four protocol.

2. Description of the Related Art

A network file system provides transparent remote access to file systems. Thus, two computers connected over a network can access each other's files in memory or stored on a storage device. Sharing of files can be restricted such that only one computer can access the files of a second computer, or limitations can be placed on which files or directories can be accessed. An example of a network file system is NFS Version four™, available from Sun Microsystems. In this network file system, and on other advanced network file systems, a virtual file system is maintained to provide a path from a root node to exported file systems.

In general, a file system provides a file “map” for a data processing system such that the data processing system can find requested files. File systems for individual data processing systems are often preserved on a hard disk drive. A virtual file system is a file system that is a file “map” of one or more remote computers and/or one or more local computers, singularly or together. Thus, a virtual file system can be a file “map” for an entire network of computers. A virtual file system is therefore also a reflection of one or more physical file systems. A virtual file system is, currently, stored in volatile memory; often of a network file system server.

Network file system software, like most software comes in different versions. In the case of network file system software produced by Sun Microsystems, network file system version four has recently been published. Thus today, more and more businesses are implementing network file system version four; however, many businesses are still relying heavily on network file system version three. When businesses are ready to migrate to the new network file system version, the business has to change both servers and clients at the same time. This change can be troublesome because network file system version four protocol is not as mature as the protocol for network file system version three.

Several methods exist to smooth the transition between network file system versions. One method to smooth the transition is to setup the servers to serve both network file system versions at the same time, and then upgrade the clients one group at a time. However, with this method not all clients will receive the benefits network file system version four offers.

### SUMMARY OF THE INVENTION

Exemplary illustrative embodiments provide for a computer implemented method, apparatus, and computer usable program code for transmitting data. In an illustrative method, transmission of the data is requested from a first data processing system to a second data processing system. The first data processing system uses a first network file system version and the second data processing system uses a second network file system version. A request is formed by requesting transmission of the data. The request is in a first protocol associated with the first network file system version. The request is received at a proxy server before transmitting the request from the first data processing system to the second data processing system. The request is converted at the proxy server to a second request. The second request is in a second protocol associated with the second network file system version. The second request is transmitted to the second data processing system and stored in a memory.

In another illustrative example, the second data processing system replies to the second request. A reply is formed in the second protocol. The reply is received at the proxy server before transmitting the reply from the second data processing system to the first data processing system. The reply is converted at the proxy server to a second reply in the first protocol. The second reply is transmitted to the first data processing system and stored in a memory.

In an illustrative example, the first network file system version is network file system version three and the second network file system is network file system version four. Additionally, the first data processing system can be capable of traversing across file systems, like a namespace of the second data processing system. Furthermore, the first data processing system can be capable of following network file system version four referrals through the proxy. The first data processing system can also be capable of performing workload balancing via a file system location command on the second data processing system. Moreover, the first data processing system can be capable of performing replication via a file system location command on the second data processing system. In a similar system, where the second file system uses a namespace concept, the proxy server can give out a unique file handle that represents each file system object within a namespace of the second data processing system.

In this case, the proxy server remaps an inode number that represents each file system object in each of a number of exported file systems to a unique number in the namespace of the second data processing system. Additionally or instead of this case, the proxy server can create a local file system, wherein the local file system corresponds to a file system of the first data processing system.

In still another illustrative example, the first protocol is a stateless protocol and the second protocol is a stateful protocol. In this case, the proxy server can handle state information on behalf of the first data processing system. In particular, the proxy server can handle state information by transmitting at least one of an open request and a close request to the second data processing system, wherein the first protocol is incapable of sending either the open request or the close request.

In yet another illustrative example, the illustrative method can include transmitting the open request. Responsive to waiting a time period during which no transmission activity occurs between the first data processing system and the second data processing system, the close request is transmitted.

The illustrative examples can also take the form of a means for requesting transmission of data from a first data processing system to a second data processing system. The means for requesting can be a data processing system, such as those described with respect to FIG. 1 and FIG. 2, and in particular can be a processor and/or a communication unit, or any other software or hardware suitable for issuing the request. The first data processing system uses a first network file system version and the second data processing system uses a second network file system version. A request is formed by requesting transmission of the data, wherein the request is in a first protocol associated with the first network file system version. Additionally provided are means for receiving the request at a proxy server before transmitting the request from the first data processing system to the second data processing system. The means for receiving the request can be a data processing system, such as those described with respect to FIG. 1 and FIG. 2, and in particular can be a processor and/or a communication unit, or any other software or hardware suitable for receiving the request. The illustrative embodiments also provide for means for converting, at the proxy server, the request to a second request. The means for converting the request can be a data processing system, such as those described with respect to FIG. 1 and FIG. 2, and in particular can be a processor and/or a communication unit, or any other software or hardware suitable for converting the request. The second request is in a second protocol associated with the second network file system version. In another illustrative embodiment are provided means for transmitting the second request to the second data processing system. The means for transmitting the second request can be a data processing system, such as those described with respect to FIG. 1 and FIG. 2, and in particular can be a processor and/or a communication unit, or any other software or hardware suitable for converting the request.

In another illustrative example, the illustrative embodiments can be provided in the form of a system. The system includes a first data processing system. The first data processing system requests transmission of data from the first data processing system to a second data processing system. The first data processing system uses a first network file system version and the second data processing system uses a second network file system version. A request is formed by requesting transmission of the data. The request is in a first protocol associated with the first network file system version. The system also includes a proxy server connected to the first data processing system and the second data processing system via a network. The proxy server receives the request before the request is transmitted from the first data processing system to the second data processing system. The proxy server converts the request to a second request provided in a second protocol associated with the second network file system version.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram representing a prior art architecture of a network file system in which the illustrative embodiments may be implemented;

FIG. 4 is a block diagram representing an architecture of a network file system, in accordance with an illustrative embodiment;

FIG. 5 is a block diagram illustrating communication between network file system clients and network file system servers via a proxy server and a network, in accordance with an illustrative embodiment;

FIG. 6 is a flowchart of a process of issuing requests from a network file system version three client to a network file system version four server, in accordance with an illustrative embodiment;

FIG. 7 is a flowchart of a method of processing a request and transmitting a reply from a network file system version four server to a network file system version three client, in accordance with an illustrative embodiment;

FIG. 8 is a flowchart illustrating a method of transmitting data between a first data processing system using a first network file system version and a second data processing system using a second network file system version, in accordance with an illustrative embodiment.

### DETAILED DESCRIPTION OF THE PREFERRED EMBODIMENT

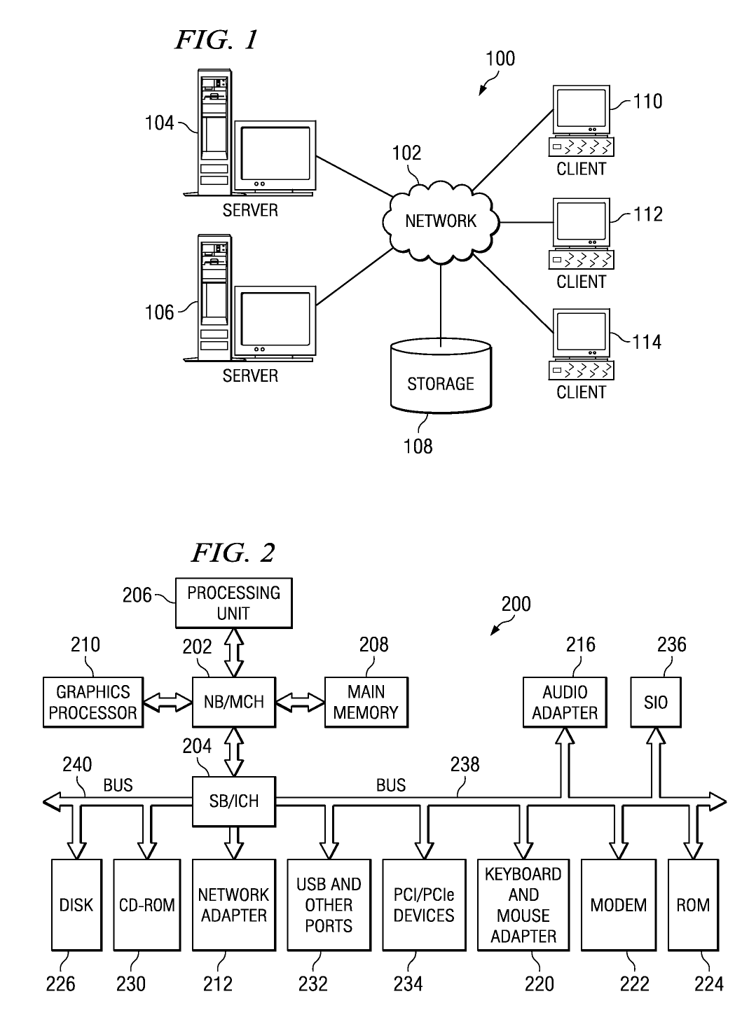

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be provided for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, and universal serial bus (USB) and other ports 232. PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provide calls to the operating system from Java™ programs or applications executing on data processing system 200. Java™ and all Java™-based trademarks a re trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to, or in place of, the hardware depicted in FIGS. 1-2. Additionally, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus, and a PCI bus. Of course, the bus system may be implemented using any type of communications fabric or architecture that provides for a transfer of data between different components or devices attached to the fabric or architecture. A communications unit may include one or more devices used to transmit and receive data, such as a modem, or a network adapter. A memory may be, for example, main memory 208 or a cache, such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Exemplary illustrative embodiments provide for a computer implemented method, apparatus, and computer usable program code for transmitting data across a network, such as network 102. In an illustrative method, transmission of the data is requested from a first data processing system to a second data processing system. The first data processing system uses a first network file system version and the second data processing system uses a second network file system version. A request is formed by requesting transmission of the data. The request is provided in a first protocol associated with the first network file system version. The request is received at a proxy server before transmitting the request from the first data processing system to the second data processing system. The request is converted at the proxy server to a second request. The second request is in a second protocol associated with the second network file system version. The second request is transmitted to the second data processing system. The second request is then stored in a memory.

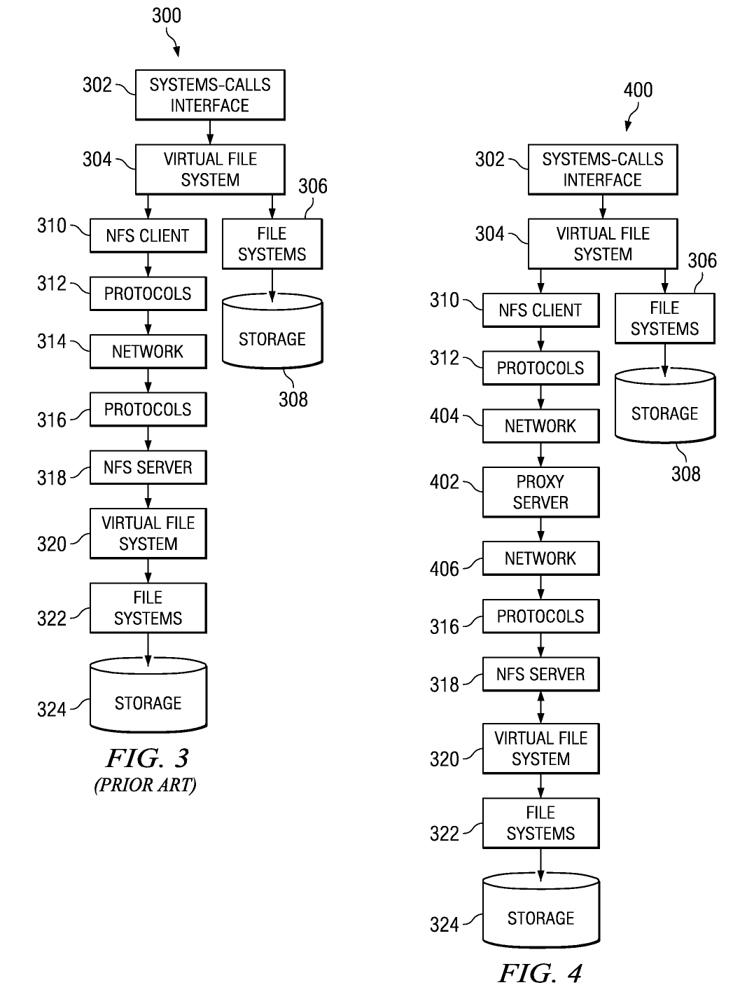

The illustrative embodiments described herein can be implemented using a virtual file system, such as that shown in FIG. 3 below. Thus, the illustrative embodiments provide a method of interfacing data processing systems using different versions of a network file system.

FIG. 3 is a block diagram representing a prior art architecture of a network file system in which the illustrative embodiments may be implemented. The prior art network file system shown in FIG. 3 can be implemented in a data processing system, such as servers 104 and 106, or clients 110, 112, and 114 shown in FIG. 1, or data processing system 200 shown in FIG. 2. Specifically, the network file system 300 shown in FIG. 3 illustrates how remote data processing systems can access files stored on physical storage systems that are located at distinct geographical locations.

Network file system 300 includes systems-calls interface 302. Systems-calls interface 302 is an interface through which a user can communicate requests to the network file system 300. For example, a user may request that a file be retrieved from a storage device of a remote data processing system. Likewise, systems-calls interface 302 can be used to perform a wide variety of operations with respect to a physical file system on a remote data processing system.

Systems-calls interface 302 communicates with virtual file system 304. Virtual file system 304 is maintained in a volatile memory of a data processing system. A virtual file system is a reflection of one or more physical file systems such as file systems 306. File systems 306 can be one or more potentially disparate file systems used by one or more potentially disparate operating systems. File systems 306 communicate with storage 308, which is a physical storage device containing one or more files and directories. File systems 306 can be used to look up files on storage 308.

Virtual file system 304 also communicates with network file system client 310. Network file system client 310 is a data processing system through which a user can access, retrieve, or otherwise manipulate a file in a remote data processing system. Network file system client 310 is used to support virtual file system 304. Network file system client 310 uses protocols 312 to communicate over a network 314 via a second set of protocols 316 that, in turn, allow communication with a second network file system server 318. Protocols 312 and 316 can be one or more of known protocols, such as remote procedure call (RPC) and/or external data representation (XDR). Network 314 can be any network such as network 102 shown in FIG. 1.

Network file system server 318 communicates with virtual file system 320. Network file system server 318 supports virtual file system 320. Virtual file system 320 communicates with file systems 322 in a manner similar to the manner in which virtual file system 304 communicates with file systems 306. File systems 322 in turn communicate with storage 324. Storage 324 is in a remote geographical location compared to storage 308. Thus, systems-calls interface 302 can be used through network file system client 310 and network file system server 318 to access storage 324.

As described above, in a high availability environment in which one or more backup network file system servers exist, problems can arise when a changeover occurs from a primary network file system server to a backup network file system server. For example, performance degradation at the client can occur when volatile file handles are used. Additionally, loss of virtual file system information can occur.

FIG. 4 is a block diagram representing an architecture of a network file system in accordance with an illustrative embodiment. Network file system version 400 shown in FIG. 4 can be implemented in a data processing system, such as servers 104 and 106, or clients 110, 112 and 114 shown in FIG. 1, or data processing system shown in FIG. 2. Specifically, network file system 400 shown in FIG. 4 illustrates use of a proxy server between network file system clients and network file system servers that use different software versions of the network file system. Network file system 400 is similar to network file system 300. Therefore, similar reference numerals in FIG. 4 correspond to the same reference numerals in FIG. 3.

The primary difference between network file 400 shown in FIG. 4 and network file system 300 shown in FIG. 3 is that proxy server 402 has been inserted between protocol 312 and 316. Thus, protocol 312 communicates with network 404, which communicates with proxy server 402 over network 406 and protocols 316. Network 404 and network 406 need not be different networks, but could be the same network, such as, for example, the Internet. Proxy 402 translates requests between network file system client 310 and network file system server 318, where network file system client 310 and network file system server 318 use different versions of network file system software.

In an illustrative example, proxy server 402 acts as a network file system version three server to network file system client 310. At the same time, proxy server 402 also acts as a network file system version four client to network file system server 318. Thus, proxy 402 receives network file system version three requests submitted by network file system client 310 and translates the network file system version three requests into network file system version four requests. Proxy system 402 then transmits the network file system version four requests to network file system server 318.

If a reply is required or desired, network file system server 318 sends a network file system version four reply to proxy server 402. Proxy 402 then converts the network file system version four reply to a network file system version three reply. Proxy server 402 then transmits the network file system version three reply to network file system client 310.

In this manner, via proxy server 402, network file system client 310, which uses network file system version three, can enjoy all the benefits provided by network file system server 318, which uses network file system version four. For example, network file system client 310 will be able to traverse the namespace across file systems of network file system server 318. Additionally, network file system client 310 will be able to follow network file system version four through proxy server 402. Furthermore, network file system client 310 will be able to perform workload balancing versions via a fs_location (file system location) command through the proxy. This command is available through network file system version four. Additionally, network file system client 310 will be able to perform replication, via a fs_locations command, through proxy 402.

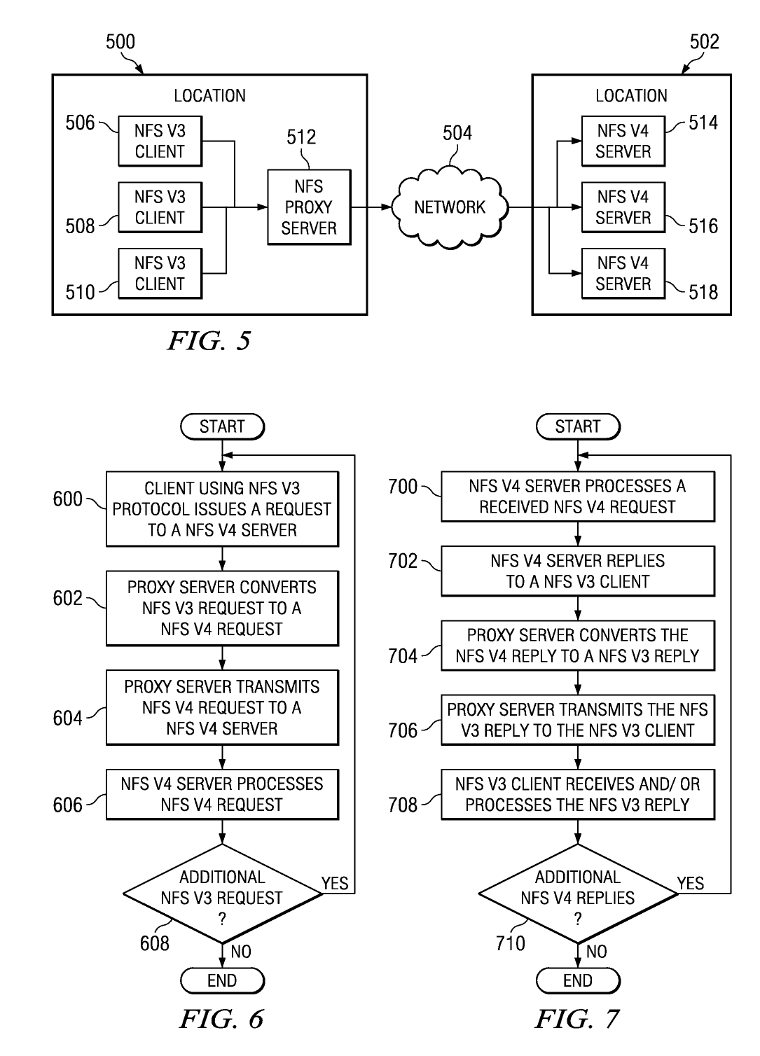

FIG. 5 is a block diagram illustrating communication between network file system clients and network file system servers via a proxy server and a network, in accordance with an illustrative embodiment. The network architecture shown in FIG. 5 can be implemented in a data processing system, such as clients 104 and 106, or server 110, 112, and 114 shown in FIG. 1, or data processing system 200 shown in FIG. 2. The network file system shown in FIG. 5 is similar to those shown in FIGS. 3 and 4, however the architecture has been simplified to show only clients, the proxy server, the network, and the servers.

Additionally, the network file system architecture shown in FIG. 5 shows that multiple clients and multiple servers can communicate over a network via a single proxy server. In other illustrative embodiments, multiple clients and multiple servers can communicate via multiple proxy shown in FIG. 5 is described using network file system versions three and four available from Sun Microsystems, the network file system architecture shown in FIG. 5 can also be implemented using other file system software.

In the illustrative examples shown in FIG. 5, network file system clients at location 500 communicate with network file system servers at location 502. Location 500 is remote from location 502. In the illustrative example shown, network file system clients and servers communicate via network 504. In particular, network file system version three clients 506, 508, and 510 communicate via proxy server 512 over network 504 with network file system version four server 514, 516, and 518. As described with respect to FIG. 4, proxy server 512 translates network file system version three requests from network file system version three clients 506, 508, and 510 into network file system version four requests that can be processed by network file system version four servers 514, 516, and 518. In turn, network file system version four replies from network file system version four servers 514, 516, and 518 are translated into network file system version three replies by proxy server 512.

In the illustrative example shown in FIG. 5, proxy server 512 is a client of network file system version four servers 514, 516, and 518. Thus, network file system version four is mounted on proxy server 512. Additionally, proxy server 512 is a server to network file system version three clients 506, 508, and 510. Thus, network file system version three is mounted on proxy server 512. Similarly, a network file system version four mount is established against network file system version four servers 514, 516, and 518, and the network file system version four mount is exported to network file system version three clients 506, 508, and 510.

When a network file system version three client request is received, proxy server 512 calls the appropriate VNOP calls to satisfy those network file system version three clients 506, 508, and 510. A “VNOP” is a function that operates on a vnode. A vnode, in turn, is a file system object, such as a file or directory. An example of a “VNOP” is a command for checking permission on a file or directory.

Because the export of the file system is a network file system version four mount, those VNOP calls are mapped into network file system version four requests. The network file system version four requests are sent network file system version four servers 514, 516, and 518 by the network file system version four client of proxy server 512. Once the network file system version four client receives the reply from network file system version four servers 514, 516, and 518, the network file system version four client will respond to the proxy VNOP calls based on the reply. Proxy server 512 then relays those responses back to network file system version three clients 506, 508, and 510.

In order to make network file system version four mounts exportable, proxy server 512 gives out a unique file handle that represents each file system object within the network file system version four namespace. Proxy server 512 can then access files across the file system boundary, as long as those file systems are within the network file system version four namespace exported by network file system version four servers 514, 516, and 518. proxy server 512 can export those file systems to network file system version three clients 506, 508, and 510 using network file system version three protocols. Thus, from the point of view of network file system version three clients 506, 508, and 510, all file systems are one giant file system.

In some illustrative examples, when using one giant file system and a network file system version three client, two file system objects can be encountered having the same inode number. To resolve this issue, proxy server 512 remaps the inode number that represents each file system object and each exported file system to a unique number in the exported network file system version four namespace. In one illustrative example, proxy server 512 creates a local file system corresponding to each network file system version three export on proxy server 512. Each file system object within the network file system version four namespace will have a corresponding file system object within that local file system. Thus, the inode number of the file system object in the local file system will be used to represent the file system object within the network file system version four namespace.

In this illustrative embodiment, network file system version four uses a stateful protocol. In a stateful protocol, information regarding transmission of replies and requests is maintained. Thus, for example, the fact that a given request to a reply has been transmitted between network file system clients and network file system servers is maintained. However, network file system version three is a stateless protocol. In a stateless protocol, information regarding requests and replies is not saved or stored. To accommodate this stateful feature, proxy server 512 handles state information on behalf of network file system version three clients 506, 508 and 510.

For example, protocols of network file system version three do not have “open” or “close” commands, due to the fact that network file system version three is stateless. However, a client of network file system version four protocol must send an open request to perform an input/output operation. Similarly, a client must send a close request after an input/output operation is complete.

Thus, when proxy server 512 processes a network file system version three read/write request from network file system clients 506, 508, or 510, proxy server 512 will send a network file system version four “open” request to network file system version four servers 514, 516, or 518. Once the read/write request is completed, proxy server 512 will send a network file system version four “close” request to network file system version four servers 514, 516, or 518. Thus, proxy server 512 can handle state information on behalf of network file system version three clients 506, 508, and 510, which otherwise would be unable to handle state information.

This process of handling state information can be improved. For example, proxy server 512 processes network file system version four “open” requests upon receiving a first input/output request from one or more of network file system version three clients 506, 508, and 510. However, proxy server 512 will not send network file system version four “close” requests to one or more of network file system version four servers 514, 516, and 518 until no input activity is detected at proxy server 512 for a predetermined period of time. The predetermined amount of time can be set by a user, determined automatically based on policies set by a user or manufacturer, or determined by any other means.

FIG. 6 is a flowchart of a process of issuing requests from a network file system version three client to a network file system version four server in accordance with an illustrative embodiment. The process shown in FIG. 6 can be implemented in a data processing system, such as clients 104 or 106, or servers 110, 112,or 114 shown in FIG. 1, or data processing system 200 shown in FIG. 2. In particular, the process shown in FIG. 6 can be implemented using a network file system proxy server, such as proxy server 402 shown in FIG. 4, or proxy server 512 shown in FIG. 5.

The process begins as a client using network file system version three protocols issues a request to a network file system version four server (step 600). A proxy server between network file system version three client and the network file system version four server converts the network file system version three requests to a network file system version four request (step 602). The proxy then transmits the network file system version four request to a network file system version four server (step 604). The network file system version four server then processes network file system version four request (step 606). The proxy server then determines whether an additional network file system version three request should be converted (step 608). If an additional network file system version three request is converted, then the process returns to (step 600) and repeats. Otherwise, the process terminates.

FIG. 7 is a flowchart of a method of processing a request and transmitting a reply from a network file system version four server to a network file system version three client in accordance with an illustrative embodiment. The process shown in FIG. 7 can be implemented in the data processing system such as clients 104 and 106, or servers 110, 112, and 114 shown in FIG. 1, or data processing system 200 shown in FIG. 2. The process shown in FIG. 7 can be implemented in proxy server 402, shown in FIG. 4, or proxy 512 shown in FIG. 5. The process shown in FIG. 7 can be implemented after the process shown in FIG. 6 has been completed. In particular, the process shown in FIG. 7 shows a process of replying to requests translated in the method shown in FIG. 6.

The process begins as a network file system version four server processes a received network file system version four request (step 700). The network file system version four server replies to a network file system version three client (step 702). A proxy server between the network file system version four server and the network file system version three client converts the network file system version four reply to a network file system version three reply (step 704). The proxy server transmits the network file system version three reply to the network file system version three client (step 706). The network file system version three client receives and/or processes the network file system version three reply (step 708). The proxy server then determines whether additional network file system version four replies should be converted (step 710). If additional network file system version four replies should be converted, then the process returns to (step 700) and repeats. Otherwise, the process terminates.

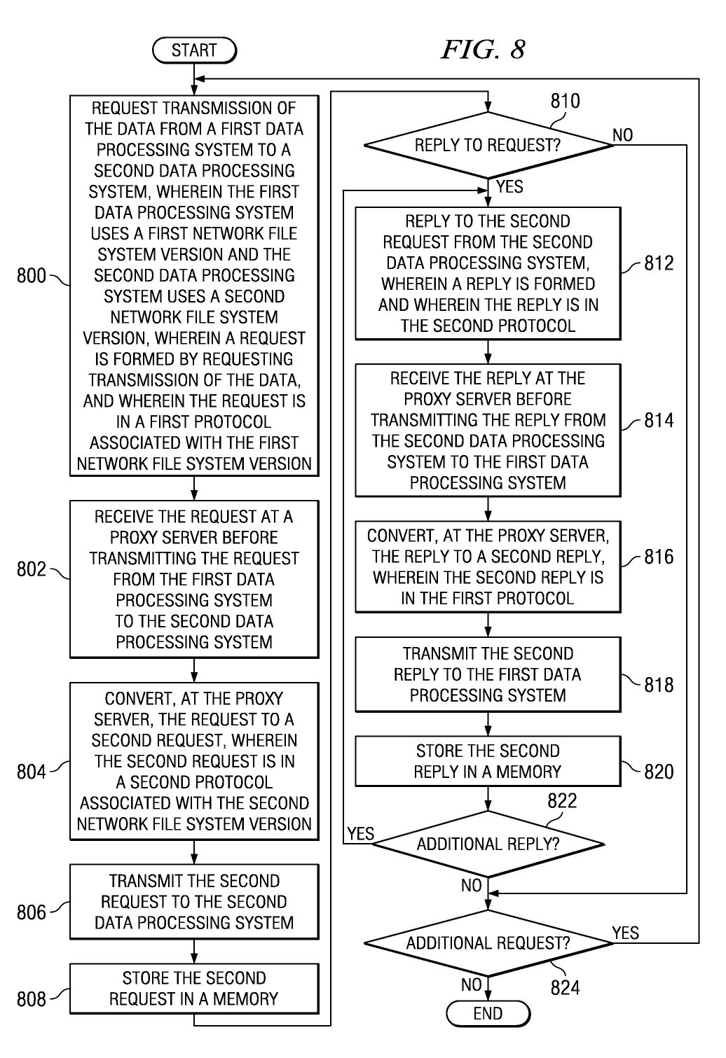

FIG. 8 is a flowchart illustrating a method of transmitting data between a first data processing system using a first network file system version and a second data processing system using a second network file system version in accordance with an illustrative embodiment. The process shown in FIG. 8 can be implemented in a data processing system, such as clients 102 and 104, or servers 110, 112, and 114 shown in FIG. 1, or data processing system 200 shown in FIG. 2. The process shown in FIG. 8 can be implemented using a proxy server, such as proxy server shown in FIG. 4 or proxy server 512 shown in FIG. 5. The process shown in FIG. 8 is an integrated request/reply transaction between network file system clients and network file system servers that use different network file system protocols or different network file system software.

The process begins as a first data processing system requests transmission of data to a second data processing system, wherein the first data processing system uses a first network file system version and the second data processing system uses a second network file system version, wherein a request is formed by requesting transmission of the data, and wherein the request is in a first protocol associated with the first network file system version (step 800). The proxy server receives the request before the request is transmitted from the first data processing system to the second data processing system (step 802). The proxy server then converts the request to a second request, wherein the second request is in a second protocol associated with a second network file system version (step 804). The proxy server then transmits the second request to the second data processing system (step 806). In an illustrative embodiment, the second request can be stored in a memory of a corresponding network file system server. The memory can be either volatile memory, such as random access memory (ROM) or a stable memory, such as a hard disk drive.

Next, the network file system server replies to the second request thereby forming a reply in the second protocol (step 810). The proxy server receives the reply before the reply is transmitted from the second data processing system to the first data processing system (step 812). The proxy server then converts the reply to a second reply, wherein the reply is in the first protocol (step 814). The proxy server then transmits the second reply to the first data processing system (step 818). In an illustrative example, the network file system client stores the second reply in the memory (step 820). In an illustrative example, the memory can be a volatile memory, such as random access memory (ROM) or a stable memory, such as a hard disk drive.

The proxy server then determines whether an additional reply is received and needs to be converted (step 822). If an additional reply is to be received and converted then the process returns to (step 810) and the process repeats. Otherwise, the proxy server determines whether an additional request is to be received and converted (step 824). If an additional request is to be received and converted then the process returns to (step 800) and repeats. Otherwise, the process terminates.

The illustrative proxy server described herein can minimize the disruption caused by converting network file system clients using network file system version three protocols to network file system version four protocols. For example, network file system version three clients will be able to traverse a namespace across file systems of a network file system version four server. Additionally, the network file system version three clients will be able to follow network file system version four referrals through the proxy server. Additionally, the network file system version three clients will be able to perform workload balancing via a fs_locations command available in network file system version four through the proxy server. Additionally, network file system version three clients will be able to perform the replication via the fs_locations command available in network file system version four through the proxy server.

Thus, the proxy server is a network file system version four client to the network file system version four server, and the proxy server is a network file system version three server to a network file system version three client. Accordingly, the network file system version three clients can enjoy most or all of the benefits offered by network file system version four, through the use of the proxy server described herein.

The invention can take the form of an entirely hardware embodiment, an entirely software embodiment, or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by, or in connection with, a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, semiconductor system (or apparatus or device), or a propagation medium. Examples of a computer-readable medium include a semiconductor or solid y state memory, magnetic tape, a removable computer diskette, a random access memory (RAM), a read-only memory (ROM), a rigid magnetic disk, and an optical disk. Current examples of optical disks include compact disk read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters. description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of transmitting data, the method comprising:
requesting transmission of the data from a first data processing system to a second data processing system, wherein the first data processing system uses a first network file system version and the second data processing system uses a second network file system version, wherein a request is formed by requesting transmission of the data, and wherein the request is in a first protocol associated with the first network file system version;
receiving the request at a proxy server before transmitting the request from the first data processing system to the second data processing system;
converting, at the proxy server, the request to a second request, wherein the second request is in a second protocol associated with the second network file system version;
transmitting the second request to the second data processing system; and
storing the second request in a memory.

2. The computer implemented method of claim 1 further comprising:
replying to the second request from the second data processing system, wherein a reply is formed and wherein the reply is in the second protocol;
receiving the reply at the proxy server before transmitting the reply from the second data processing system to the first data processing system;
converting, at the proxy server, the reply to a second reply, wherein the second reply is in the first protocol;
transmitting the second reply to the first data processing system; and
storing the second reply in a memory.

3. The computer implemented method of claim 1 wherein the first network file system version is network file system version three and wherein the second network file system is network file system version four.

4. The computer implemented method of claim 2 wherein the first network file system version is network file system version three and wherein the second network file system is network file system version four.

5. The computer implemented method of claim 3 wherein the first data processing system is capable of traversing across file systems a namespace of the second data processing system.

6. The computer implemented method of claim 3 wherein the first data processing system is capable of following network file system version four referrals through the proxy.

7. The computer implemented method of claim 3 wherein the first data processing system is capable of performing workload balancing via a file system location command on the second data processing system.

8. The computer implemented method of claim 3 wherein the first data processing system is capable of performing replication via a file system location command on the second data processing system.

9. The computer implemented method of claim 4 wherein the first data processing system is capable of performing replication via a file system location command on the second data processing system.

10. The computer implemented method of claim 1 wherein the proxy server gives out a unique file handle that represents each file system object within a namespace of the second data processing system.

11. The computer implemented method of claim 10 wherein the proxy server remaps an inode number that represents each file system object in each of a number of exported file systems to a unique number in the namespace of the second data processing system.

12. The computer implemented method of claim 10 wherein the proxy server creates a local file system, wherein the local file system corresponds to a file system of the first data processing system.

13. The computer implemented method of claim 1 wherein the first protocol is a stateless protocol and the second protocol is a stateful protocol.

14. The computer implemented method of claim 13 wherein the proxy server handles state information on behalf of the first data processing system.

15. The computer implemented method of claim 14 wherein the proxy server handles state information by transmitting at least one of an open request and a close request to the second data processing system, wherein the first protocol is incapable of sending either the open request or the close request.

16. The computer implemented method of claim 15 further comprising:
transmitting the open request; and
responsive to waiting a time period during which no transmission activity occurs between the first data processing system and the second data processing system, transmitting the close request.

17. A computer program product comprising:
a computer usable medium having computer usable program code for transmitting data, the computer program product including:
computer usable program code for requesting transmission of the data from a first data processing system to a second data processing system, wherein the first data processing system uses a first network file system version and the second data processing system uses a second network file system version, wherein a request is formed by requesting transmission of the data, and wherein the request is in a first protocol associated with the first network file system version;
computer usable program code for receiving the request at a proxy server before transmitting the request from the first data processing system to the second data processing system;
computer usable program code for converting, at the proxy server, the request to a second request, wherein the second request is in a second protocol associated with the second network file system version;
computer usable program code for transmitting the second request to the second data processing system; and
computer usable program code for storing the second request in a memory.

18. The computer program product of claim 17 further comprising:
computer usable program code for replying to the second request from the second data processing system, wherein a reply is formed and wherein the reply is in the second protocol;
computer usable program code for receiving the reply at the proxy server before transmitting the reply from the second data processing system to the first data processing system;
computer usable program code for converting, at the proxy server, the reply to a second reply, wherein the second reply is in the first protocol;
computer usable program code for transmitting the second reply to the first data processing system; and
computer usable program code for storing the second reply in a memory.

19. The computer program product of claim 17 wherein the first network file system version is network file system version three and wherein the second network file system is network file system version four.

20. The computer program product of claim 18 wherein the first network file system version is network file system version three and wherein the second network file system is network file system version four.

21. The computer program product of claim 19 wherein the first data processing system is capable of traversing across file systems a namespace of the second data processing system.

22. The computer program product of claim 19 wherein the first data processing system is capable of following network file system version four referrals through the proxy.

23. The computer program product of claim 19 wherein the first data processing system is capable of performing workload balancing via a file system location command on the second data processing system.

24. The computer program product of claim 19 wherein the first data processing system is capable of performing replication via a file system location command on the second data processing system.

25. The computer program product of claim 20 wherein the first data processing system is capable of performing replication via a file system location command on the second data processing system.

26. The computer program product of claim 17 wherein the proxy server gives out a unique file handle that represents each file system object within a namespace of the second data processing system.

27. The computer program product of claim 26 wherein the proxy server remaps an inode number that represents each file system object in each of a number of exported file systems to a unique number in the namespace of the second data processing system.

28. The computer program product of claim 26 wherein the proxy server creates a local file system, wherein the local file system corresponds to a file system of the first data processing system.

29. The computer program product of claim 17 wherein the first protocol is a stateless protocol and the second protocol is a stateful protocol.

30. The computer program product of claim 29 wherein the proxy server handles state information on behalf of the first data processing system.

31. The computer program product of claim 30 wherein the proxy server handles state information by transmitting at least one of an open request and a close request to the second data processing system, wherein the first protocol is incapable of sending either the open request or the close request.

32. The computer program product of claim 31 further comprising:
computer usable program code for transmitting the open request; and
computer usable program code for, responsive to waiting a time period during which no transmission activity occurs between the first data processing system and the second data processing system, transmitting the close request.

33. A data processing system comprising:
a processor;
a bus connected to the processor;
a computer usable medium connected to the bus, wherein the computer usable medium contains a set of instructions for transmitting data, wherein the processor is adapted to carry out the set of instructions to:
request transmission of the data from a first data processing system to a second data processing system, wherein the first data processing system uses a first network file system version and the second data processing system uses a second network file system version, wherein a request is formed by requesting transmission of the data, and wherein the request is in a first protocol associated with the first network file system version;
receive the request at a proxy server before transmitting the request from the first data processing system to the second data processing system;
convert, at the proxy server, the request to a second request, wherein the second request is in a second protocol associated with the second network file system version; and
transmit the second request to the second data processing system.

34. A data processing system comprising:
means for requesting transmission of data from a first data processing system to a second data processing system, wherein the first data processing system uses a first network file system version and the second data processing system uses a second network file system version, wherein a request is formed by requesting transmission of the data, and wherein the request is in a first protocol associated with the first network file system version;
means for receiving the request at a proxy server before transmitting the request from the first data processing system to the second data processing system;
means for converting, at the proxy server, the request to a second request, wherein the second request is in a second protocol associated with the second network file system version; and
means for transmitting the second request to the second data processing system.

35. A system comprising:
a first data processing system, wherein the first data processing system requests transmission of data from the first data processing system to a second data processing system, wherein the first data processing system uses a first network file system version and the second data processing system uses a second network file system version, wherein a request is formed by requesting transmission of the data, and wherein the request is in a first protocol associated with the first network file system version; and
a proxy server connected to the first data processing system and the second data processing system via a network, wherein the proxy server receives the request before the request is transmitted from the first data processing system to the second data processing system, wherein the proxy server converts the request to a second request, and wherein the second request is in a second protocol associated with the second network file system version.
